(19) United States
(12) Patent Application Publication
(10) Pub. No.: US 2008/0210678 A1
(43) Pub. Date: Sep. 4, 2008

(54) Towel and garment warmer

(76) Inventor: Jeff Crane, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/713,135

(22) Filed: Mar. 1, 2007

(51) Int. Cl. F27B 17/00; F25B 29/00

(52) U.S. Cl. 219/201; 219/392

(57) ABSTRACT

A towel and garment warmer comprising an elongated cabinet having sidewalls that define a warming chamber with an open upper end that is closed by a lid pivotally attached to a sidewall. The cabinet is configured to allow the articles to be warmed to hang in the warming chamber. Attached to the bottom surface of the lid is one or more hooks or other securing mechanisms configured to secure the articles in the warming chamber. A source of warm air is located at the lower end of the heating chamber to direct warm air upward so as to substantially evenly warm the articles. Air is discharged from the warming chamber through vents located in the lid. A cooling system has a source of cool air in communication with the warming chamber to allow the user to inject cool air so as to cool and freshen the articles therein.

### CROSS-REFERENCE TO RELATED APPLICATIONS

None.

### BACKGROUND OF THE INVENTION

A. Field of the Invention

The field of the present invention relates generally to apparatuses for warming towels and garments prior to being worn. More particularly, the present invention relates to such apparatuses that removably receive one or more towels and/or garments into a warming chamber for transferring heated air thereto. Even more particularly the present invention relates to towel and garment warming apparatuses that also include a system for selectively applying cool air to the towels and/or garments therein.

B. Background

When stepping out of a bath or shower, most people prefer to dry themselves off with a warm towel and/or wrap themselves up in a warm robe prior to stepping out of the bath area and then to dress themselves in warm clothes, including underwear, socks and lingerie. Hereinafter, the robe, underwear, socks, lingerie or other clothing items are referred to as a “garment.” The desire for a warm towel or garment is particularly strong on colder, winter mornings where the user is often forced to step from a warm bath, shower or shower area into a relatively colder room. Unless the towel or garment had been recently removed from a clothes dryer or had been previously placed on or next to a radiator or space heater, a person is unlikely to enjoy the benefits of a warm, post bath or shower towel or garment. This is particularly the situation when a person is staying in a hotel, motel or other non-resident room where access to a dryer to withdraw a warm towel or garment immediately after the bath or shower is generally not practical or even possible. Placing a towel or garment on or near enough to a radiator or space heater to sufficiently warm the towel or garment so that it feels warm to the user creates the potential for overheating or even fire. As a result although most people prefer a warm towel or garment after taking a bath or shower, generally this is considered a luxury that is not readily available unless one is at an upscale spa or the like.

In addition to a standard clothes dryer, various apparatuses are available for warming a towel and/or garment. Generally, the prior art towel and garment warming apparatuses are of two types, the first type of apparatus having a rod, rail or like device over which the towel or garment is laid and the second type being a box-like container in which the towel or garment is received. The typical heated rod or rail apparatus comprises at least one generally horizontally disposed heated member over which the towel or garment is draped. Typically, the heated member is tubular and has a warm to hot fluid passing through the interior thereof so as to heat the exterior surface of the heated member and transfer that heat to the towel or garment thereon. In one somewhat common example, the heated member is hydraulically connected to a hot water supply system, such as a domestic hot water supply, so hot water will flow through the member and warm the towel or garment. These apparatuses are commonly referred to as towel rails. It is also known to use other fluids or even other heating mechanisms, such as electric coils or the like, to heat the heated member and warm the towel or garment draped thereon. Another such apparatus utilizes hot or warm air as the heating fluid.

Several problems are known to exist with regard to use of heated rail apparatuses. One such problem is that the portion of the towel or garment laying against the heated member is provided with a relatively significant amount of heat while the remaining portions of the towel or garment does not get exposed to much heat and, therefore, may not feel particularly warm to the user. This problem is due primarily to the fact that cloth and other materials which towels and garments are commonly made out of are generally not known to be very heat conductive. When using hot or warm air to heat the heated member, providing a plurality of side or downwardly disposed holes in the heated member can at least partially overcome this problem by directing warm air towards the inside surfaces of the draped towel. In addition to the uniformity of heating problem, the ability to utilize heated rail apparatuses is somewhat limited as they generally required the device to be built into the system or require somewhat substantial remodeling of the bath area to connect it to the hot water supply system or a supply of heated air in order to utilize the apparatus.

A modified version of the towel rail type of apparatus discussed above is disclosed in U.S. Pat. No. 6,935,279 to Bosworth, which describes a towel rail or holder having an elongated tube formed into the general shape of conical helix that has an upwardly facing opening which is sized and configured to receive a towel inside the conical volume. A heated fluid, such as hot water, flows through into one end of the tube, through the tube and then out the tube at the bottom of the conical helix to warm the towel placed in the conical volume. While the apparatus of this patent has some benefits with regard to contact against the towel, it still has many of the same limitations as the standard towel rail apparatuses.

An example of the box-like container type of apparatus for heating towels and/or garments is disclosed in U.S. Pat. No. 5,569,403 to Swanson, et al. This patent describes a towel warmer having a heater blower disposed in the upper portion of a cabinet that is configured to direct heated air downward over a towel hung draped over a rack on the cabinet door. After passing over the towel, the heated air passes upwardly along outer tubular members on each side of the cabinet and then back down into the heater blower. Another example of this type of apparatus is the towel warmer console cabinet disclosed in U.S. Pat. No. 6,005,227 to Pappas. This apparatus comprises a console having a circulating fan at the bottom that, with the top closed, circulates air from a side air passage in which is disposed a heater to heat the air that is discharged into the main chamber. The main chamber has four upright posts that support the towel or other article to be warmed. A thermostat controls the temperature inside the apparatus. Yet another example of this type of apparatus is the towel warmer disclosed in U.S. Pat. No. 6,046,436 to Hunts, which comprises an airtight enclosure having a side door through which the towel is placed onto a perforated shelf for warming. A blower at the rear of the enclosure circulates air past a coil heater and discharges the heated air over the towel. A heating cycle timer and temperature controller provides a predetermined amount of time and temperature range. Yet another example of this type of apparatus is the towel and garment warmer disclosed in U.S. Pat. No. 6,774,343 to Ibanez, which comprises a top opening cabinet having an air permeable grid or screen that divides the cabinet into an upper section and a lower section. A rack in the upper section holds the towels or other articles to be heated and a heating mechanism, comprising one or more incandescent light bulbs, in the lower section provides the heat.

In addition to desiring to warm a robe or garment on a cold day, many people desire to cool a robe or garment on hot, muggy day. As well known, during certain period times of the year most places in the United States, as well as other places in the world, have hot, muggy weather. As a result of the heat and/or humidity, when a person steps out of the bath or shower he or she will be drying off with a towel or putting on a garment that is itself warm or moist. On these days, instead of warming the towel or garment, it would be more desirable to cool the towel and/or garment to freshen it up before contacting the person's body. For functional and convenience purposes, it would be beneficial if the same apparatus could warm towels and garments on cold days and cool towels on garments on hut, muggy days. No such apparatus is presently available.

Although the foregoing prior art describes apparatuses that are generally useful for warming a towel or garment, they have limitations which have prevented their acceptance by persons who desire such an apparatus. For instance, some of the prior art apparatuses do not direct warm air through the towel or garment in a manner that effectively warms the entire article. In addition, the prior art box-like apparatuses are generally not adaptable to efficient use in a typical, relatively small bath area. Instead, these apparatuses are configured in a manner that utilizes too much of the limited floor space in the bath area. What is needed, therefore, is a towel and garment warmer which receives the towel or garment in the warming chamber in a manner that allows the warm air directed therein to effectively and efficiently warm the towel and/or garment and is configured to better utilize the available floor space and is aesthetically pleasing. The preferred apparatus should be configured to direct warm air through a towel or garment hanging inside the warming chamber so the warm air will effectively warm the entire towel or garment. The preferred apparatus should be configured with a fan and heater device which directs warm air through the heating chamber of the apparatus to warm a towel or garment therein. Preferably, the apparatus is provided with a hanging mechanism that is easy to use and which effectively hangs a towel and/or garment in the heating chamber. The preferred apparatus should be provided with a mechanism that can cool a towel and/or garment on days when it is hot and/or muggy to freshen the towel or garment before use or wearing.

### SUMMARY OF THE INVENTION

The towel and garment warmer of the present invention solves the problems and provides the benefits identified above. That is to say, the present invention discloses a towel and garment warmer that is configured to receive one or more towels and/or garments inside a chamber defined by an upstanding, elongated cabinet that permits the towels or garments to substantially hang inside the chamber. In a preferred embodiment of the present invention, the towel and garment warmer is configured for efficient use of limited floor space, such as exists in the typical bath area, and to effectively warm the entire towel and/or garment hanging inside the cabinet. In one preferred embodiment, the cabinet of the towel and garment warmer of the present invention has a generally triangular cross-section. The towel and garment warmer of the present invention directs warm air upward through a chamber defined by the sidewalls of the cabinet to effectively distribute the warm air around a towel or garment hanging inside the chamber. In the preferred embodiment, the towel and garment warmer of the present invention is provided with a hook or like mechanism which is easy to utilize to hang a towel and/or garment inside the apparatus. In a preferred embodiment, the towel and garment warmer includes a cooling system that is configured to direct cool air into the cabinet chamber to cool the towel and/or garment hanging therein.

In one general aspect of the present invention, the towel and garment warmer comprises a generally elongated cabinet that has one or more upstanding sidewalls which define a warming chamber therein. In a preferred embodiment, the cabinet has three sidewalls which define a generally triangular-shaped warming chamber and adjacent sidewalls are joined by a support member that, at the lower end, defines legs for the cabinet. The warming chamber has an open upper end through which towels and garments are received into the warming chamber. A lid is pivotally attached to one of the sidewalls so as to substantially close the open upper end of the warming chamber. In the preferred embodiment, a spring-loaded hinge is utilized to facilitate movement of the lid between its closed position for warming the towels and garments and its open position for placing the towels and garments into the warming chamber or removing them therefrom. One or more securing mechanisms, which in the preferred embodiment is a hook, are attached to the bottom surface of the lid to secure the towels and/or garments inside the warming chamber. The cabinet is configured so the towels and/or garments substantially hang from the hook in the warming chamber to more evenly warm them. A source of warm air, such as a combination heater and fan device, is positioned at the lower end of the warming chamber to direct warm air upward through the towels and/or garments hanging in the warming chamber. The source of warm air draws in air through the inlets defined by the legs which support the lower end of the warming chamber in spaced apart relation to a support surface. An on/off switch allows the user to control the operation of the source of warm air. Warm air is discharged through venting apertures in the lid. A cooling system can be utilized with the present invention to allow the user to selectively inject a set quantity of cool air into the warming chamber to cool and freshen the towels and/or garments therein on hot, muggy days. In a preferred configuration, the cooling system comprises a source of cool air, such as a bottle of compressed gas, a valve to control release of the cool air, a hose that connects the source of cool air to cool air vents that open into the warming chamber and a support bracket which removably supports the source of cool air so that it may be refilled or replaced as necessary.

Accordingly, the primary objective of the present invention is to provide an improved towel and garment warmer that provides the advantages discussed above and overcomes the disadvantages and limitations associated with presently available towel and garment warming apparatuses.

It is also an important object of the present invention to provide a towel and garment warmer that is configured to receive one or more towels and/or garments inside a chamber defined by a generally elongated, upstanding cabinet that allows the towels or garment to substantially hang therein.

It is also an important object of the present invention to provide a towel and garment warmer which more efficiently utilizes the limited space of the typical bath area.

It is also an important object of the present invention to provide a towel and garment warmer that is easy to use, relatively inexpensive to manufacture and adaptable to a variety of different sizes and configurations.

It is also an important object of the present invention to provide a towel and garment warmer that is provided with a cooling system which is configured to inject cool air into the chamber in which the towel and/or garment hangs so as to cool and freshen the towel or garment on hot, muggy days.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a left side perspective view of a towel and garment warmer configured according to a preferred embodiment of the present invention showing the lid partially open with a robe and a towel hanging therefrom into the warming chamber defined by the cabinet;

FIG. 2 is a front view of the towel and garment warmer shown in FIG. 1 with the lid closed and the warming chamber empty;

FIG. 3 is a left side perspective view of the towel and garment warmer shown in FIG. 2;

FIG. 4 is a right side perspective view of the towel and garment warmer shown in FIG. 2;

FIG. 5 is a left side view of the towel and garment warmer shown in FIG. 2;

FIG. 6 is a right side view of the towel and garment warmer shown in FIG. 3;

FIG. 7 is a back view of the towel and garment warmer shown in FIG. 2;

FIG. 8 is a top plan view of the towel and garment warmer shown in FIG. 2;

FIG. 9 is a plan view of the inside wall of the lid of the towel and garment warmer shown in FIG. 2;

FIG. 10 is an isolated top plan view of the towel and garment warmer shown in FIG. 2 with the lid open to show the warming chamber;

FIG. 11 is a bottom plan view of the towel and garment warmer shown in FIG. 2;

FIG. 12 is a back view of the preferred embodiment of the towel and garment warmer of the present invention showing a cooling system attached thereto for use to provide a blast of cool air inside the warming chamber;

FIG. 13 is a top plan view of the towel and garment warmer shown in FIG. 12;

FIG. 14 is an isolated view of the cooling system of the towel and garment warmer shown in FIG. 12; and

FIG. 15 is an alternative configuration for the towel and garment warmer shown in FIG. 2.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily directed to a cabinet having a substantially triangular configuration, those skilled in the relevant art will readily understand that this is merely for purposes of simplifying the present disclosure and that the present invention is not so limited, as the present invention is equally adaptable to other elongated, upstanding configurations.

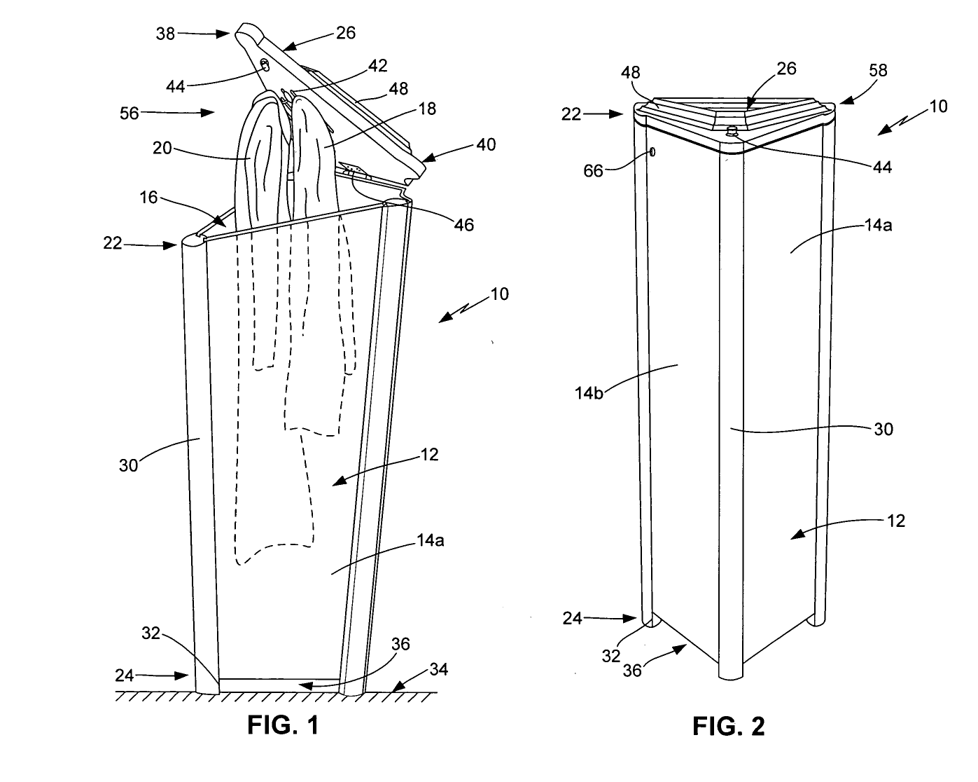

A towel and garment warmer that is manufactured out of the components and configured pursuant to a preferred embodiment of the present invention is shown generally as 10 in the figures. Towel and garment warmer 10 comprises a generally elongated cabinet 12 made up of one or more upstanding sidewalls, such as those identified as 14a, 14b and 14c (collectively referred to as 14) that define a warming chamber 16 configured to receive one or more articles, such as towel 18 and garment 20, shown in FIG. 1, therein for warming. As best shown in FIG. 1, warming chamber 16 has an open upper end 22 and a lower end 24, with the upper end 22 being sized and configured to receive one or more articles (i.e., towel 18 and garment 20) through the open upper end 22. As set forth in more detail below, towel and garment warmer 10 also has a lid 26 pivotally attached to one of the sidewalls 14 that is configured to substantially close the open upper end 22 of warming chamber 16. The sidewalls 14 of cabinet 12 form a generally elongated, upright, hollow tubular shaped structure in which warm air is circulated past articles 18 and/or 20 to warm them for the comfort and convenience of the person who will use and/or wear them. This shape and configuration of cabinet 12 is desired as it reduces the amount of floor space needed for towel and garment warmer 10 in generally space-limited bath areas. In addition, the elongated, upright, tubular shape also allows the articles placed therein to generally hang in warming chamber 16, as shown in FIG. 1, so that the warm air may be more efficiently and effectively circulated around the articles to warm substantially the entire article. In addition, this configuration also provides a generally more aesthetically pleasing towel and garment warmer 10 compared to those in the prior art.

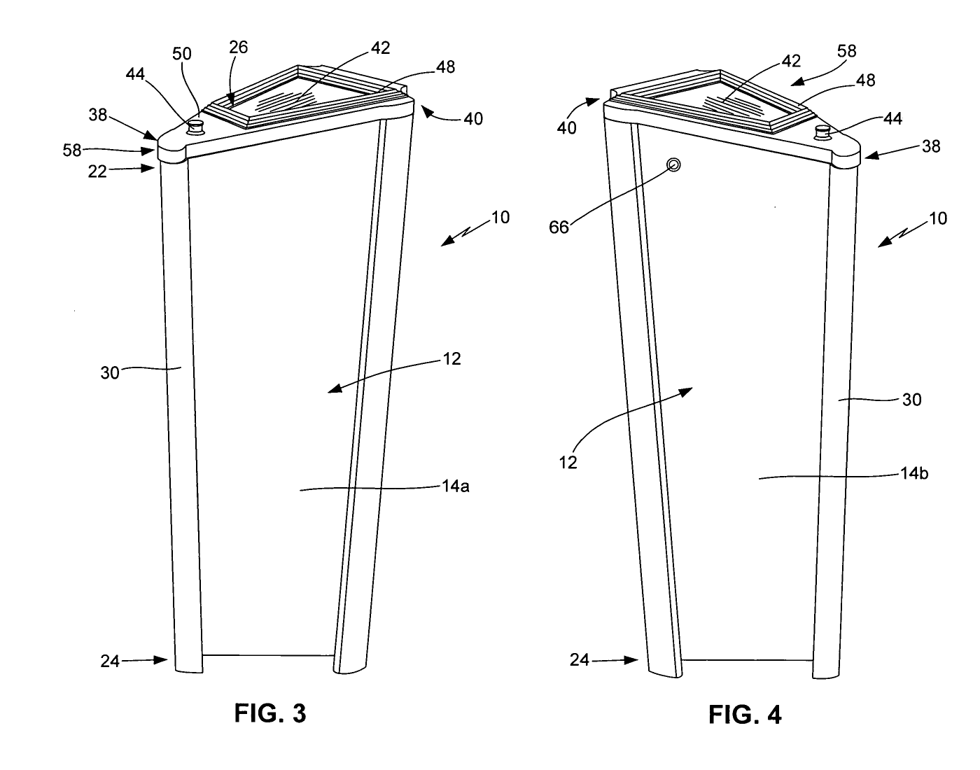

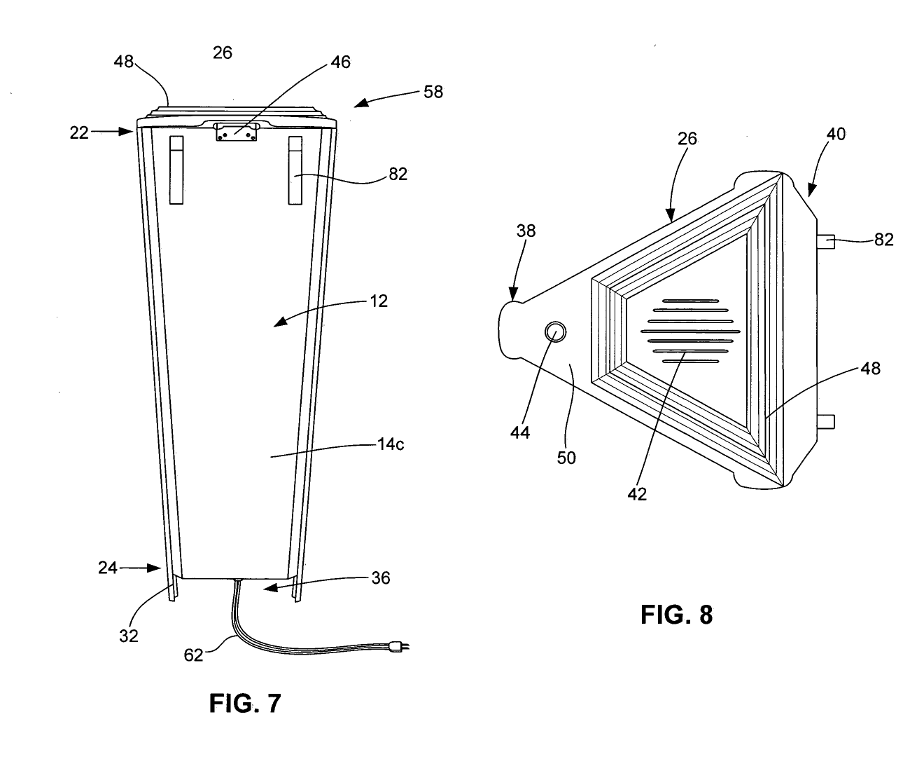

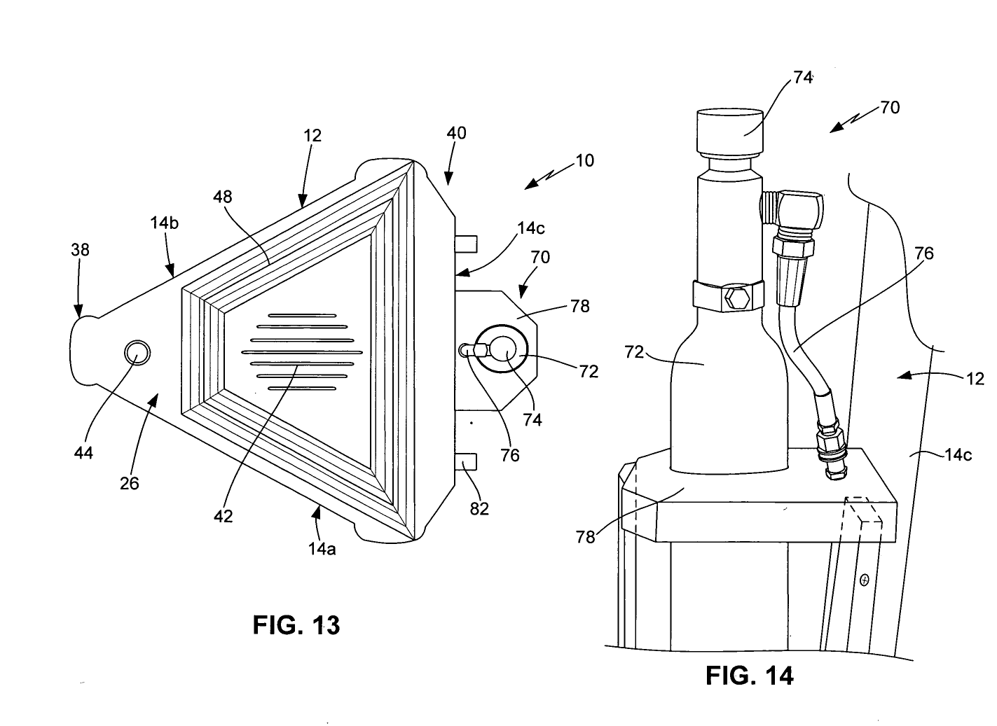

In a preferred embodiment of the present invention 10, cabinet 12 has three sidewalls, shown as left sidewall 14a, right sidewall 14b and back sidewall 14c, that results in warming chamber 16 having a generally triangular cross-section, as shown in FIGS. 1 through 14. Those skilled in the art will readily appreciate that cabinet 12 can also be formed in a variety of other shapes and still retain the desired generally upright, elongated configuration. For instance, sidewalls 14 of cabinet 12 can form warming chamber 16 into a generally cylindrical, oval, rectangular, diamond or a variety of other suitable or desired cross-sections. Cabinet 12 can be made out of a variety of different materials, including wood, metal, plastic, fiberglass, composites or combinations of these materials. In one preferred embodiment, cabinet 12 is made out of a good quality wood to provide a fine furniture look.

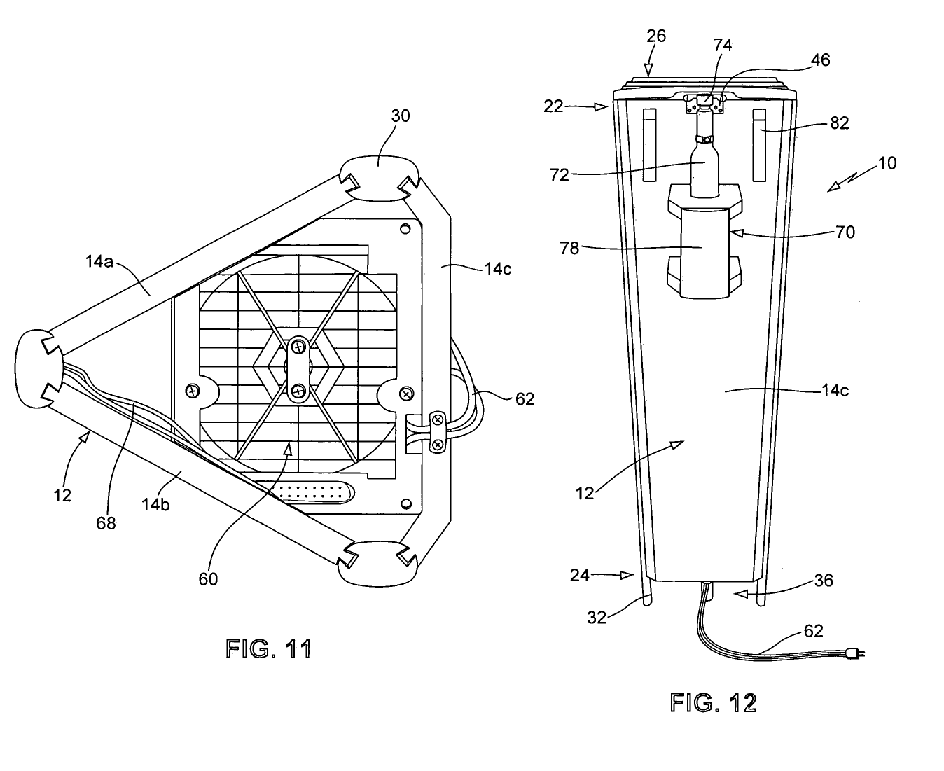

As stated above, the preferred embodiment of cabinet 12 has three sidewalls 14a, 14b, and 14c defining warming chamber 16 into a generally triangular cross-section. As shown in the figures, the preferred embodiment also utilizes an elongated support member 30 that connects adjacent sidewalls, such as 14a/14b, 14a/14c and 14b/14c, and projects slightly outward from the plane formed by each of sidewalls 14. The connection between support member 30 and the respective pair of adjacent sidewalls 14 in the preferred embodiment, wherein cabinet 12 is made out of a wood or wood-like material, is best shown in the bottom view of FIG. 11. In addition to providing a more aesthetically pleasing look, support members 30 define legs 32 that support cabinet 12 such that the lower end 24 of warming chamber 16 is disposed in spaced apart relation to support surface 34, as shown in FIG. 1, to define an inlet 36 for the source of warm air, described in detail below, that warms the articles 18/20 inside warming chamber 16.

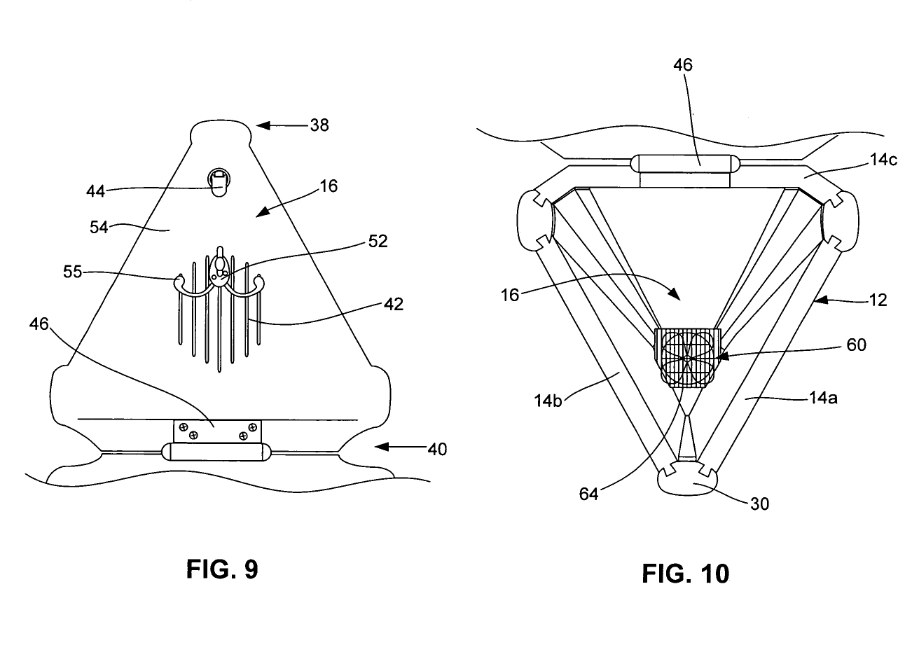

As set forth above, pivotally attached to one of the sidewalls 14 of cabinet 12 is lid 26 that substantially closes the open upper end 22 of warming chamber 16. In the preferred embodiment, lid 26 has a front end 38 and a back end 40 and is shaped and configured to substantially correspond to the cross-section of cabinet 12 at the upper end 22 of warming chamber 16. Unlike some prior art towel/garment warmers, it is not necessary that lid 26 sealably close warming chamber 16 as, in the preferred embodiment, the warm air is not circulated inside cabinet 12. In fact, lid 26 preferably includes one or more venting apertures, which are shown as slots 42 in the figures (with the best views being shown in FIGS. 8 and 9), that are configured to vent warm air from inside warming chamber 16. In the preferred embodiment of towel and garment warmer 10, lid 26 also has a latching mechanism 44 that is configured to engage cabinet 12 when lid 26 is closed thereon and be selectively disengaged by the user when he or she desires to open cabinet 12 to access warming chamber 16 therein, such as when towel 18 and/or garment 20 is placed into or removed from warming chamber 16. A hinge 46 at the back end 40 of lid 26 pivotally connects lid 26 to the back sidewall 14c, as best shown in FIGS. 1, 5 through 7 and 9. Preferably hinge 46 is of the spring-loaded type that urge lid 26 back into its closed position and prevent lid 26 from fully falling back in the rearward direction to prevent damage thereto. If desired, a plurality of hinges 46 can connect lid 26 to cabinet 12. As known to those skilled in the art, a variety of other types of pivoting mechanisms are also suitable for use with towel and garment warmer 10. If desired, lid 26 can also include a design feature, shown as 48, on the top surface 50 thereof for improved aesthetic purposes.

To secure the articles, such as towel 18 and garment 20, inside warming chamber 16, the preferred embodiment of towel and garment warmer 10 of the present invention includes an article securing mechanism 52 at the upper end 22 of warming chamber 16 that is configured to secure articles 18/20 inside warming chamber 16 in a generally hanging position, as shown in FIG. 1. In the preferred embodiment, as best shown in FIG. 9, securing mechanism 52 is a hook that is attached to the bottom surface 54 of lid 26. The present inventor has specially developed a hook 52 for use with towel and garment warmer 10 that comprises three individual hook members 55 that allows the user to hang three separate articles 18/20 thereon without having to share a hook member 56. If desired, securing mechanism 52 can comprise one or more separate hooks that each attach to the bottom surface 54 of lid 26. As will be readily appreciated by those skilled in the art, a variety of other types of securing mechanisms 52 can be utilized with towel and garment warmer 10 and still accomplish the objectives of the present invention. Such securing mechanisms 52 can include a clamp-type device, a rod configured as an elongated hook or other devices. Any such securing mechanism 52 should be configured such that it will securely hold articles 18/20 in a hanging position inside warming chamber 16 when lid 16 is closed and ensure that they will remain thereon while lid 16 is moved between its open position 56, as shown in FIG. 1, and its closed position 58, as shown in FIGS. 2 through 7. In this manner, the user can place articles 18/20 on securing mechanism 52 or remove them from securing mechanism 52 when lid 26 is tilted back in its open position 56 and then be able to pivot lid 26 to its closed position 58 with articles 18/20 remaining thereon.

To provide the necessary warm or hot air to heat articles 18/20 inside warming chamber 16, the towel and garment warmer 10 of the present invention includes a source of warm air, shown as 60, at the lower end 24 of warming chamber 16, as best shown in FIGS. 10 and 11. In the preferred embodiment, source of warm air 60 is a space heater type of device that comprises an electric heater and fan/blower built as an integral unit that connects to a source of electric power, such as an outlet (not shown) via an electric power cord 62 shown in FIGS. 11 and 12. Such heating/fan devices are commonly known and commercially available. Alternatively, source of warm air 60 can comprise separate heating and fan components that are cooperatively configured to discharge warm air inside warming chamber 16 at or near the lower end 24 thereof. The source of warm air 60 should be sized and configured so as to deliver a desired level of heat and air flow inside warming chamber 16 so that it will efficiently and effectively warm articles 18/20. The sizing of the source of warm air (i.e., the electric heater/fan) should consider such factors as the size of warming chamber 16 and the thickness and type of material used for articles 18/20 likely to be utilized with towel and garment warmer 10. As shown in FIG. 10, a screen 64 should be utilized to ensure that articles 18/20 do not fall into the heating/fan components of the source of warm air 60. Screen 64 can be integral with the source of warm air 60 or be a separate component in spaced apart relation thereto.

Towel and garment warmer 10 also includes an appropriately configured on/off switch 66, shown in FIGS. 2, 4 and 6, which is electrically connected to the source of warm air 60, such as by wires 68 shown in FIG. 11, to allow the user to selectively turn on or turn off the source of warm air 60 when warmer 10 is used or no longer needed (i.e., when articles 18/20 are removed from heating chamber 16). As will be readily understood by those skilled in the art, though not shown in the figures, towel and garment warmer 10 can also include a mechanism (not shown) that is configured to automatically turn off the source of warm air 60 when lid 26 is lifted to its open position 56 so that warm air is not discharged to outside of cabinet 12 without first warming articles 18/20. In addition, towel and garment warmer 10 can also include a timer mechanism (not shown) that allows the user to turn on the source of warm air 60 for a specified amount of time, after which it is automatically turned off, and/or a thermostat (not shown) that allows the user to set a specific temperature at which the source of warm air 60 is automatically turned off to avoid potential problems with leaving the source of warm air continuously on. If desired, controller unit (not shown) can also be utilized to control the on/off operation of the source of warm air 60 and, if used, the timer and thermostat mechanisms. As well known to those skilled in the art, if also desired the towel and garment warmer 10 can include a wireless control mechanism (not shown) to allow the user to remotely control the operation of towel and garment warmer 10.

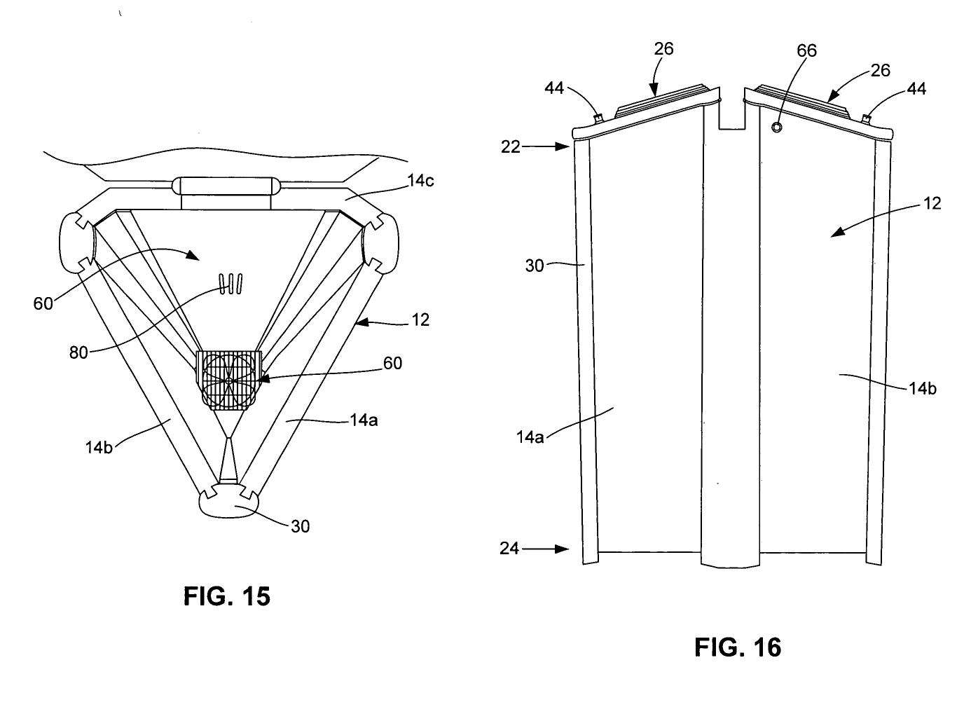

The preferred embodiment of the towel and garment warmer 10 of the present invention also includes a cooling system, shown as 70 in FIGS. 12 through 15, that is configured to direct cool air into warming chamber 16. As well known to persons who live in areas where heat and humidity is a problem during certain times of the year, hot and muggy conditions can adversely affect the feel of towels 18 and garments 20 when they are used or put on. During these times of the year, operation of the source of warm air 60 is generally not needed and, instead, the cooling system 70 can be utilized to cool and freshen towel 18 or garment 20 in warming chamber 16. In the preferred embodiment, as best shown in FIG. 14, cooling system 70 comprises a source of cool air 72, such as a tank of compressed carbon dioxide gas (or other cooling gases known to those skilled in the art), a valve 74 in operable connection with the source of cool air 72, one or more hoses 76 hydraulically interconnecting the source of cool air 70 to warming chamber 16 and a support bracket 78 configured to removably support the source of cool air 72 on cabinet 12. In the preferred configuration, support bracket 78 is fixedly attached to the back sidewall 14c of cabinet 12 and configured to receive and support the gas tank 72 therein. Preferably, valve 74 is configured to release a controlled, specific quantity of cool air, as opposed to remaining open and, thereby, potentially emptying the source of cool air 72, into warming chamber 16. Hoses 76 from the source of cool air 72 direct the cool air into warming chamber 16 in a manner that avoids or at least minimizes loss of the cool air to the exterior of cabinet 12. In the preferred configuration, hoses 76 direct the cool air from the source of cool air 70 from the lower portion of support bracket 78, which is in abutting relation with back sidewall 14c, through one or more cool air vents 80 disposed in back sidewall 14c, as best shown in FIG. 15. Although a single aperture can suffice for cool air vents 80, having multiple slot-shaped vents may be more likely to distribute the cool air inside warming chamber 16 where it can cool and freshen the articles 18/20 therein. If desired, a fan or the like can be utilized with cooling system 70 to better distribute the cool air inside warming chamber 16. As known to those skilled in the art, cooling system 70 can also include a timer and/or thermostat or be connected to such components that are utilized with the source of warm air 60. If a controller unit is utilized, cooling system 70 can be integrated with the controller unit so the user may control the operation of cooling system 70 along with the heating components described above.

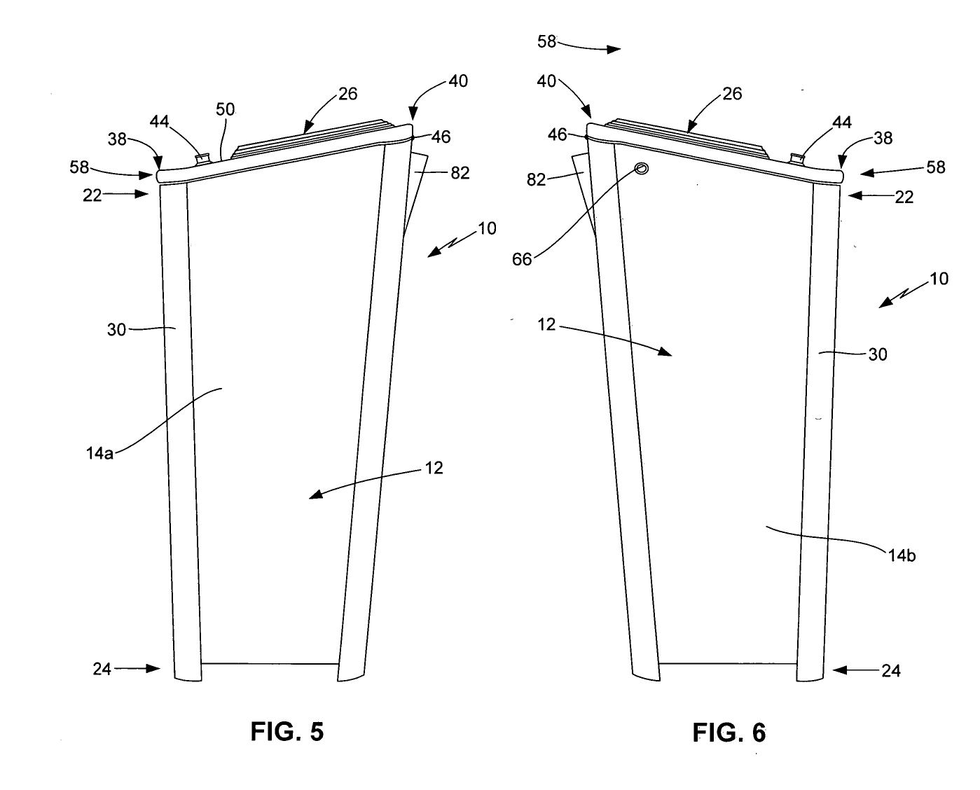

The preferred embodiment of the towel and garment warmer 10 of the present invention also includes one or more lid supports 82, best shown in FIGS. 5 through 7, on the back sidewall 14c of cabinet 12 that are configured to support lid 26 and any articles on securing mechanism 52 when it is in its open position 56. Lid supports 82 will assist hinge 46 in holding lid 26 open and reduce or eliminate that likelihood that lid 26 will be overloaded with articles 18/20 and damage hinge 46.

As stated above, towel and garment warmer 10 of the present invention can be provided in a variety of different configurations. One such alternative configuration is shown in the embodiment of FIG. 16. In this embodiment, towel and garment warmer 10 essentially comprises cabinet 12 that is a pair of the triangular-shaped cabinets described above that are placed in a back to back configuration, each with its own warming chamber 16 and lid 26. As with the embodiments described above, the cabinet 12 of this configuration has upstanding sidewalls 14 that provide an elongated cabinet 12 for receiving articles 18/20 in the warming chambers 16. Preferably, each has its own on/off switch 66 and source of warm air 60 so that they may be operated independently of each other. In this manner, the user can warm (or cool) more than one set of articles 18/20 at a time. The cabinet 12 will need to be configured to allow each lid 26 to independently open without interference from the other lid(s) 26. As with the triangular embodiment described above, this dual-chamber configuration can be provided in a variety of different shapes, including a pair of circular, oval, square or rectangular shapes. In addition, if desired the towel and garment warmer 10 can be provided with more than two warming chambers, such as a configuration that has three, four or more separate, independently operated heating/cooling chambers and systems.

In use, the towel and garment warmer 10 of the present invention is placed in a wash area, such as bathroom or the like, where it will be convenient for the user to obtain a warm towel 18 or garment 20 therefrom. In the preferred embodiment, power cord 62 is plugged into a standard outlet. When a warm towel 18 or garment 20 is desired, the user pushes the button associated with latching mechanism 44 to disengage lid 16 and move it to its open position 56. Once in the open position 56, with lid 26 resting on lid supports 82, the user can hang a towel 18 and/or garment 20 on securing mechanism 52 and place the remaining portion of the article(s) 18/20 inside warming chamber 16. The user then closes lid 26 to place it in it closed position 58. Once closed, the user then activates the source of warm air 60 by pushing the on/off switch 66 to on. If provided, the user sets the timer and/or the thermostat to control the operation of the source of warm air 60. The source of warm air 60 draws in outside air through inlet 36 and discharges it into warming chamber 16 at its lower end 24. The warm air rises up through the articles 18/20 in warming chamber 16 to substantially evenly warm them. Once the articles 18/20 have reached their desired warming, the user turns off the source of warm air 60 by pushing the on/off switch 66 and then raises lid 26 to its open position 56 so that he or she may remove the articles 18/20 from securing mechanism 52 to use the warm towel 18 and/or put on the warm garment 20. If a cool article 18/20 is desired, the user utilizes the cooling system 70 by placing towel 18 and/or garment 20 in warming chamber 16 and operating valve 74 to inject a set, specific quantity of cool air from the source of cool air 72 into warming chamber 16 to cool and freshen the articles 18/20 therein. When the source of cool air 72 is emptied, in the embodiment with the gas bottle (as shown), then the user will disengage the source of cool air 72 from support bracket 78 and hose 76 so that he or she may replace with a similarly configured source of cool air 72. As such, the use is able to selectively utilize towel and garment warmer 10 of the present invention to either warm or cool one or more towels 18 and/or garments 20.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A towel and garment warmer for warming an article, comprising:
an elongated cabinet having one or more upstanding sidewalls defining a warming chamber having an open upper end and a lower end, said warming chamber configured to receive said article through said open upper end;
a lid pivotally attached to one of said sidewalls and configured to substantially close said open upper end;
an article securing means disposed at said upper end of said warming chamber for securing said article in said cabinet; and
a source of warm air at said lower end of said warming chamber configured to direct warm air upward toward said upper end of said warming chamber.

2. The towel and garment warmer according to claim 1, wherein said article securing means is attached to a bottom surface of said lid.

3. The towel and garment warmer according to claim 2, wherein said article securing means is a hook.

4. The towel and garment warmer according to claim 1 further comprising one or more venting apertures in said lid.

5. The towel and garment warmer according to claim 1, wherein said cabinet comprises three or more sidewalls.

6. The towel and garment warmer according to claim 5, wherein said cabinet has three sidewalls and said warming chamber has a generally triangular cross-section.

7. The towel and garment warmer according to claim 5, wherein said cabinet further comprises an elongated support member disposed between and interconnecting adjacent pairs of said sidewalls.

8. The towel and garment warmer according to claim 7, wherein each of said support members define a leg supporting the lower end of said warming chamber in spaced apart relation to a supporting surface to define an inlet for said source of warm air.

9. The towel and garment warmer according to claim 1 further comprising a cooling system having a source of cool air in fluid flow communication with said warming chamber, said cooling system configured to selectively direct cool air into said warming chamber.

10. The towel and garment warmer according to claim 9, wherein said cooling system is attached to said cabinet.

11. The towel and garment warmer according to claim 9, wherein said source of cool air is a tank of compressed gas.

12. The towel and garment warmer according to claim 9, wherein said cooling system further comprises a valve in operable connection with said source of cool air.

13. The towel and garment warmer according to claim 12, wherein said valve is configured to selectively direct a specific quantity of cool air into said warming chamber.

14. The towel and garment warmer according to claim 1 further comprising one or more lid supports on one of said sidewalls of said cabinet, said one or more lid supports configured to support said lid when in an open position.

15. A towel and garment warmer for warming an article, comprising:
an elongated cabinet having one or more upstanding sidewalls defining a warming chamber having an open upper end and a lower end, said warming chamber configured to receive said article through said open upper end;
a lid pivotally attached to one of said sidewalls and configured to substantially close said open upper end;
an article securing means attached to a bottom surface of said lid for securing said article in said cabinet;
a source of warm air at said lower end of said warming chamber, said source of warm air configured to selectively direct warm air upward toward said upper end of said warming chamber; and
a cooling system having a source of cool air in fluid flow communication with said warming chamber, said cooling system configured to selectively direct cool air into said warming chamber.

16. The towel and garment warmer according to claim 15, wherein said cooling system comprises a support bracket attached to said cabinet.

17. The towel and garment warmer according to claim 16, wherein said source of cool air is a tank of compressed gas received in said support bracket.

18. The towel and garment warmer according to claim 15, wherein said cooling system further comprises a valve in operable connection with said source of cool air.

19. A towel and garment warmer for warming an article, comprising:
an elongated cabinet having three upstanding sidewalls defining a substantially triangular-shaped warming chamber having an open upper end and a lower end, said warming chamber configured to receive said article through said open upper end;
a lid pivotally attached to one of said sidewalls and configured to substantially close said open upper end, said lid having one or more venting apertures;
an hook attached to a bottom surface of said lid for securing said article in said cabinet;
a source of warm air at said lower end of said warming chamber, said source of warm air configured to selectively direct warm air upward toward said upper end of said warming chamber; and
a cooling system having a source of cool air in fluid flow communication with said warming chamber, said cooling system configured to selectively direct cool air into said warming chamber.

20. The towel and garment warmer according to claim 19, wherein said cabinet further comprises an elongated support member disposed between and interconnecting adjacent pairs of said sidewalls, each of said support members defining a leg supporting the lower end of said warming chamber in spaced apart relation to a supporting surface so as to define an inlet for said source of warm air.
